(19) United States
(12) Patent Application Publication
(10) Pub. No.: US 2017/0350352 A1
(43) Pub. Date: Dec. 7, 2017

(54) EVAPORATED FUEL PROCESSING DEVICES

(71) Applicant: AISAN KOGYO KABUSHIKI KAISHA, Obu-shi (JP)

(72) Inventor: Tetsuya ISHIKAWA, Obu-shi (JP)

(73) Assignee: AISAN KOGYO KABUSHIKI KAISHA, Obu-shi (JP)

(21) Appl. No.: 15/612,149

(22) Filed: Jun. 2, 2017

(30) Foreign Application Priority Data
Jun. 3, 2016 (JP) 2016-111751

(51) Int. Cl. F02M 25/08; B01D 53/04; B01J 20/28; B01J 20/20; B01J 20/26

(52) U.S. Cl. CPC F02M 25/0854; B01J 20/20; B01J 20/262; B01J 20/2803; B01J 20/2805; B01D 53/04; B01D 2253/102; B01D 2253/304; B01D 2253/34; B01D 2257/702; B01D 2259/40086

(57) ABSTRACT

An evaporated fuel processing device for processing evaporated fuel generated in a fuel tank includes a hollow case and an elastic adsorption member press-fit in the hollow case. The elastic adsorption member has a rectangular prismatic block shape. The elastic adsorption member includes an air-permeable elastic body and constituent granules of a granular adsorbent material disposed in the air-permeable elastic body. The constituent granules of a granular adsorbent material are configured to adsorb and desorb evaporated fuel.

### CROSS-REFERENCE TO RELATED APPLICATIONS

This application claims priority to Japanese patent application serial number 2016-111751 filed Jun. 3, 2016, the contents of which are incorporated herein by reference in their entirety for all purposes.

### STATEMENT REGARDING FEDERALLY SPONSORED RESEARCH OR DEVELOPMENT

Not applicable.

### BACKGROUND

The present disclosure relates to an evaporated fuel processing device for processing evaporated fuel generated in a fuel tank, wherein the fuel tank is mounted on a vehicle, such as an automobile.

Japanese Laid-Open Patent Publication No. H03-47455 discloses an evaporated fuel processing device that serves to prevent evaporated fuel generated in a fuel tank from flowing out to the atmosphere. The evaporated fuel processing device includes a case, which is filled with granular activated carbon comprising a granular form of adsorbent material to adsorb and desorb evaporated fuel. Japanese Patent No. 5022337 discloses honeycomb adsorbent materials that also act as a granular adsorbent material. A diameter of the honeycomb adsorbent granules is equal to or more than 1.8 mm and equal to or less than 11 mm, and the ratio of its length to diameter is 1/4 to 3/1. The honeycomb adsorbent materials have a plurality of through-holes extending from one end to the other end of the constituent granules.

According to the aforementioned conventional evaporated fuel processing devices, granular adsorbent material (activated carbons) filled in the case vibrate due to vehicle vibration etc. Even if the granular adsorbent material comprises the honeycomb adsorbent materials, they may also vibrate. As a result of the vibrations, the granular adsorbent material may be broken up into fine pieces. The broken, fine pieces of the granular adsorbent material can increase the resistance to air passing through the case, and can also increase the noise caused by vibration of the granular adsorbent material.

### SUMMARY

In one exemplary embodiment of the present disclosure, an evaporated fuel processing device for processing evaporated fuel generated in a fuel tank includes a hollow case, and an elastic adsorption member with a block shape housed within the case. The elastic adsorption member includes a granular adsorbent material comprising granules that adsorb and desorb evaporated fuel, and an air-permeable elastic body having elasticity and air-permeability. The constituent granules of the granular adsorbent material are randomly arranged within the air-permeable elastic body.

The air-permeable elastic body may elastically support the granular adsorbent material while ensuring air-permeability with respect to the same. Consequently, the vibration of the granular adsorbent materials caused while the evaporated fuel processing device is vibrated, may be reduced. Further, pulverization of the granular adsorbent material may be reduced and/or prevented, thereby reducing and/or preventing an increase in flow resistance of air passing through the case due to the presence of fine powders. The reduction or prevention of pulverization of the granules and the creation of fine powders may also reduce the noise caused by mutual rubbing of the granules due to the vibration.

In another aspect of the disclosure, the elastic adsorption member may be supported within the case utilizing elasticity of the air-permeable elastic body. In this way, the elastic adsorption member can be supported in a predetermined position within the case without providing any additional components.

In another aspect of the disclosure, the air-permeable elastic body may be configured to include urethane foam. Therefore, the air-permeable elastic body may elastically support the constituent granules of the granular adsorbent material utilizing the nature of the urethane foam while ensuring air-permeability with respect to said material.

In another aspect of the disclosure, each constituent granule of the granular adsorbent material may include a through-hole that has a columnar shape and penetrates in an axial direction of the constituent granule. Therefore, air-flow resistance of an area including the granular material where the constituent granules have the through-holes is smaller than air-flow resistance of an area including columnar granular adsorbent material without the constituent granules having through-holes. Further, adsorption performance of the granular material can be increased because the surface area of each constituent granule is enlarged due to presence of the through holes.

### BRIEF DESCRIPTION OF THE DRAWINGS

For a detailed description of the preferred embodiments of the invention, reference will now be made to the accompanying drawings.

FIG. 1 is a schematic view showing an evaporated fuel system including an embodiment of an evaporated fuel processing device;

FIG. 2 is a perspective view showing a partially removed elastic adsorption member of the evaporated fuel processing device of FIG. 1;

FIG. 3 is a perspective view showing a constituent granule of the granular adsorbent material of FIG. 2;

FIG. 4 is a cross-sectional view showing an embodiment of an evaporated fuel processing device;

FIG. 5 is a cross-sectional view showing an embodiment of an evaporated fuel processing device; and

FIG. 6 is a cross-sectional view showing an embodiment of an evaporated fuel processing device.

### DETAILED DESCRIPTION

The following discussion is directed to various exemplary embodiments. However, one skilled in the art will understand that the examples disclosed herein have broad application, and that the discussion of any embodiment is meant only to be exemplary of that embodiment, and not intended to suggest that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but not function. The drawing figures are not necessarily to scale. Certain features and components herein may be shown exaggerated in scale or in somewhat schematic form and some details of conventional elements may not be shown in interest of clarity and conciseness.

In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection, or through an indirect connection via other devices, components, and connections. In addition, as used herein, the terms “axial” and “axially” generally mean along or parallel to a central axis (e.g., central axis of a body or a port), while the terms “radial” and “radially” generally mean perpendicular to the central axis. For instance, an axial distance refers to a distance measured along or parallel to the central axis, and a radial distance means a distance measured perpendicular to the central axis.

Representative, non-limiting embodiments according to the present disclosure will now be described with reference to the drawings. Referring now to FIG. 1, an evaporated fuel processing device 10 is mounted on a vehicle, such as an automobile. For purposes of clarity and further description, the up-down and left-right directions are determined with reference to FIG. 1. However, it should be appreciated that the orientation of the evaporated fuel processing device 10 is not specifically limited to the orientation shown in FIG. 1.

As shown in FIG. 1, the evaporated fuel processing device 10 includes an outer case 12 made of resin. In this embodiment, the case 12 is formed as a hollow rectangular box. In particular, the case 12 includes a rectangular prismatic case main body 13 with a top (upper surface) and a cover plate 14 that closes a lower opening of the case main body 13. An interior of the case main body 13 is divided by a partition wall 16 into large and small chambers 18 and 20. The larger chamber 18 serves as a main adsorption chamber 18 and the smaller chamber 20 serves as an auxiliary chamber 20. A communication passage 22 is defined at a lower end of the case main body 13. The communication passage 22 facilitates fluid communication between the main adsorption chamber 18 and the auxiliary chamber 20.

A tank port 24, a purge port 25 and an atmospheric port 26 are arranged in sequence from right to left at the upper surface of the case main body 13. The tank port 24 and the purge port 25 are in direct fluid communication with the main adsorption chamber 18. An upper area of the main adsorption chamber 18 is further divided by a vertically oriented partition plate 28, into a tank port 24 sub compartment and a purge port 25 sub compartment. The atmospheric port 26 is in direct fluid communication with auxiliary chamber 20 and acts as an open conduit, and facilitates fluid communication of the auxiliary chamber 20 with the atmosphere exterior to the device 10.

The tank port 24 is in fluid communication with a fuel tank 32 (specifically, an air layer in the fuel tank 32) through an evaporated fuel passage 30. The purge port 25 is in fluid communication with an intake pipe 37 of an engine 36 through the purge passage 34. The purge passage 34, in turn, is in fluid communication with the intake pipe 37, located downstream (where the downstream direction is from the intake pipe 37 to the purge passage 34) from a throttle valve 38 that is used for controlling intake air volume. A purge valve 39 is installed in the middle of the purge passage 34. The purge valve 39 is controlled to selectively to open or close by a controller (e.g., ECU) not shown.

A plurality of constituent granules of the granular adsorbent material 41 are filled in the main adsorption chamber 18. These adsorbent granules are deposited in a randomly arranged manner. In an embodiment, granular activated carbon may be used as the granular adsorbent material 41. This granulated carbon, which may be produced through granulating granular or powdery activated carbon, or alternatively may comprise crushed activated carbon with binder, may be used as the granular activated carbon in said embodiment. This adsorption material may have various shapes, for example, a spherical shape, a round shaft shape, a protruding polygonal shape, or a recessed polygonal shape.

As shown in FIG. 1, an air-permeable porous plate 43 is arranged at a lower area of the adsorption chamber 18 to cover the lower opening of the adsorption chamber 18. The porous plate 43 includes a plurality of through-holes penetrating through the plate in a vertical thickness direction of the plate for facilitating fluid communication between the adsorption chamber 18 and the communication passage 22. A spring member 44, such as a coil spring, is interposed between the porous plate 43 and the bottom cover plate 14. The spring member 44 biases upward and pushes the porous plate 43 and the adsorbent material 41 up toward the upper surface of the case 12 by utilizing its elasticity based on compression of said member 44. An upper surface and a lower surface of the constituent granules of the deposited adsorbent material 41 are respectively covered with a sheet filter (not shown) made of a resin non-woven fabric or urethane foam etc.

The auxiliary adsorption chamber 20 consists of three chambers, i.e. the upper, middle and lower chambers. The upper chamber of the auxiliary chamber 20 is filled with a plurality of constituent granules of the granular adsorption material 46 in a deposited manner. An elastic adsorption member 53 is accommodated in the middle chamber of the auxiliary chamber 20. The lower chamber of the auxiliary chamber 20 is filled with a plurality of constituent granules of the granular adsorption material 48 in a deposited manner. The adsorption materials 46 and 48 are unbounded grains that may be the same as the adsorbent material 41 filled in the main adsorption chamber 18 or alternatively can be granular activated carbon of a different variety than the adsorbent material 41.

An air-permeable porous plate 50 is provided at a lower area of the auxiliary chamber 20 to cover the lower opening of the adsorption chamber 20. The porous plate 50 includes a plurality of through-holes penetrating through the plate in a vertical thickness direction of the plate for facilitating fluid communication between the auxiliary adsorption chamber 20 and the communication passage 22. A spring member 51, such as a coil spring, is interposed between the porous plate 50 and the bottom cover plate 14. The spring member 51 biases upward and pushes the porous plate 50 and the adsorbent material 41 up toward the upper surface of the case 12 by utilizing its elasticity based on compression of said member 51. The upper and lower surfaces of the constituent granules of the deposited adsorbent materials 46 and 48 are respectively covered with a sheet filter (not shown) made of a resin non-woven fabric or urethane foam etc. The elastic adsorption member 53 is arranged between the deposited adsorption materials 46 and 48.

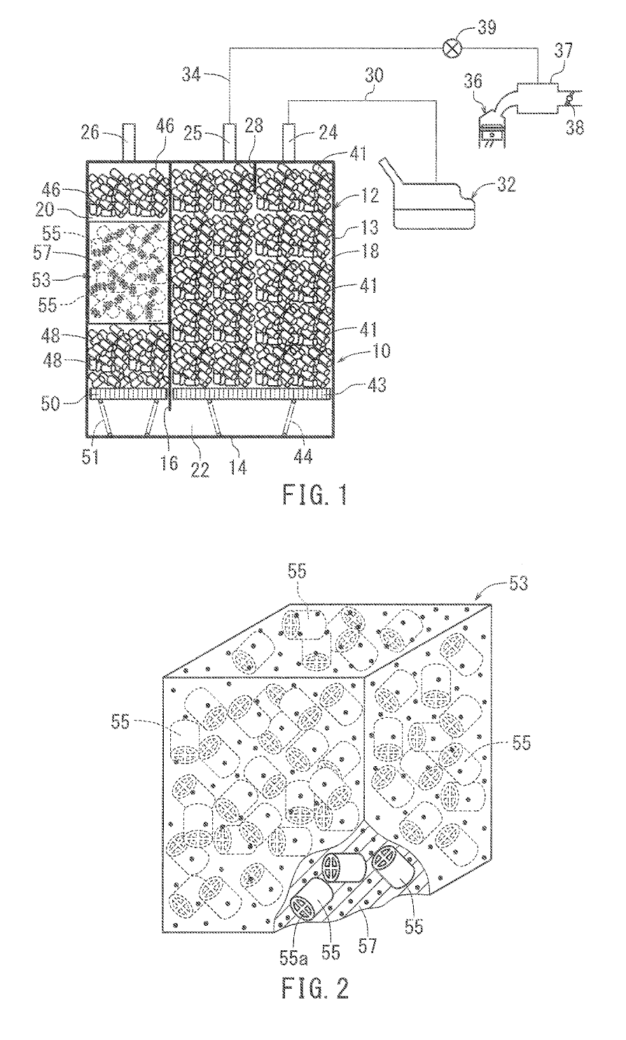

As shown in FIG. 2, the elastic adsorption member 53 accommodated in the middle chamber is formed into a rectangular block. The elastic adsorption member 53 integrally includes constituent granules of granular adsorbent material 55 and an air-permeable elastic body 57. The constituent granules of granular adsorbent material 55 adsorb and desorb evaporated fuel emissions and are randomly arranged in the air-permeable elastic body 57.

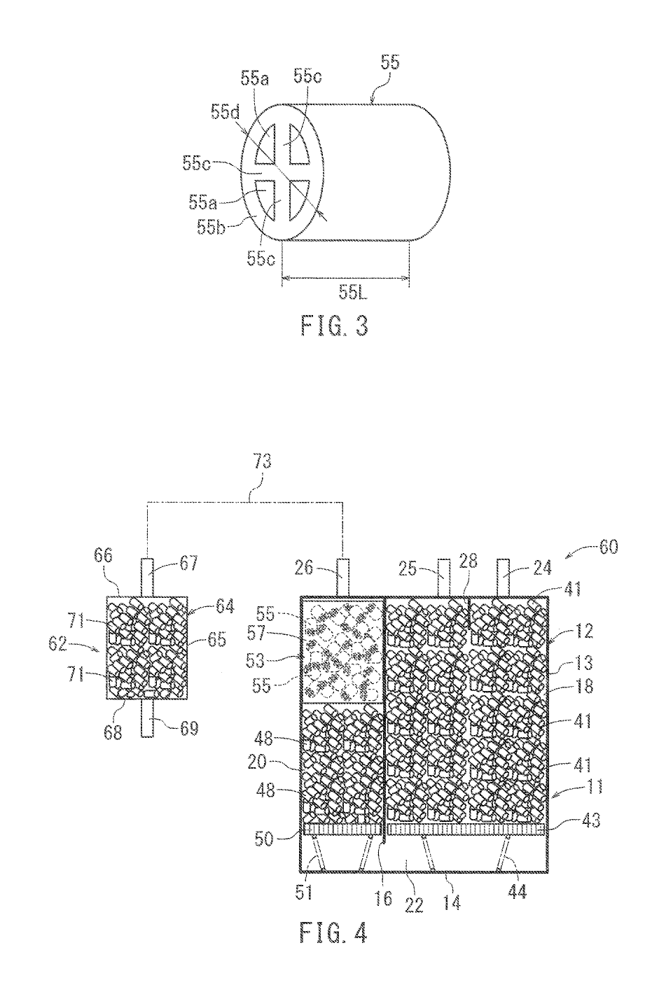

As shown in FIG. 3, the constituent granule of the granular adsorbent material 55 is comprised of granulated carbon produced through granulating granular or powdery activated carbon with binder. The constituent granules of the granular adsorbent material 55 may include through-holes 55a (four in an exemplary embodiment) having a columnar shape and penetrating in the longitudinal axial direction of the constituent granule, as further shown in FIG. 3. Specifically, the constituent granules of the granular adsorbent material 55 each have a cylindrical tubular portion 55b and four partition ribs 55c which divide the interior of the tubular portion 55b in an equiproportional manner along the inner circumference of 55b. In particular, the four partition ribs 55c form a cross-shaped cross section, and thus, form four through-holes 55a in a constituent granule of the granular adsorbent material 55. Each of the through-holes has a fan-shaped cross sectional shape. A diameter 55d of the granular adsorbent material 55 may be, for example, smaller than a length 55L of the granular adsorbent material 55 (e.g., diameter 55d<length 55L), where the length lies in the longitudinal direction. The diameter 55d of the granular adsorbent material 55 may also be equal to the length 55L of the granular adsorbent material 55 (e.g., diameter 55d=length 55L) or larger than the length 55L of the granular adsorbent material 55 (e.g., diameter 55d>length 55L).

The diameter 55d of the granular adsorbent material 55 is larger than a mean grain diameter of the constituent granules of the adsorption materials 41, 46 and 48. For example, when the mean grain diameter of the constituent granules of the adsorption materials 41, 46 and 48 is 2 mm, the diameter 55d and the length 55L of the granular adsorption material 55 may be 3 to 7 mm, and preferably 4 to 6 mm. The mean grain diameter may be an equivalent volume-based mean grain diameter determination of the respective constituent granules of the mentioned granular adsorption materials. The volume-based mean grain diameter is determined as a grain diameter obtained at the point of time when 50% of the total volume of the granular adsorption materials have been sorted after grains with a specific volume are sequentially sieved from smaller ones.

The air-permeable elastic body 57 is made of urethane foam and has elasticity and air-permeability. The air-permeable elastic body 57 is molded while the plurality of the constituent granules of the granular adsorbent material 55 are included therein and is then formed into a rectangular block. The size of each granular adsorbent material 55 is determined in view of the size of the air through-holes in the air-permeable elastic body 57 such that all or majority of the plurality of the granules of the granular adsorbent material 55 are elastically captured in the air-permeable elastic body 57.

A flat cross section of the elastic adsorption member 53 in a free state has a rectangular shape, which is approximately similar to and larger than a flat cross section of the auxiliary adsorption chamber 20. The elastic adsorption member 53 is arranged in the auxiliary adsorption chamber 20 of the case 12 by press-fitting or an interference fit. Specifically, the elastic adsorption member 53 is supported in the auxiliary adsorption chamber 20 of the case 12 utilizing elasticity of the air-permeable elastic body 57 (e.g., the elastic adsorption member 53 is compressed within the auxiliary adsorption chamber 20). Accordingly, the elastic adsorption member 53 pushes the adsorption material 46 deposited in the upper chamber of the auxiliary adsorption chamber 20 toward the top surface of the case 12.

As shown in FIG. 1, the evaporated fuel processing system includes the evaporated fuel processing device 10, the evaporated fuel passage 30, the fuel tank 32, the purge passage 34, the intake pipe 37 and the purge valve 39, etc.

While the engine 36 of the vehicle is stopped, evaporated fuel generated, for example, in the fuel tank 32 is introduced into the main adsorption chamber 18 through the evaporated fuel passage 30. This evaporated fuel is adsorbed by the adsorption material 41 in the main adsorption chamber 18. The residual evaporated fuel which is not adsorbed by the adsorption material 41 in the main adsorption chamber 18 is introduced into the auxiliary adsorption chamber 20 through the communication passage 22. Subsequently, said residual evaporated fuel is successively adsorbed by the adsorption material 48 in the lower chamber of the auxiliary adsorption chamber 20, granular adsorbent material 55 of the elastic adsorption member 53 in the middle chamber, and the adsorption material 46 in the upper chamber.

While the engine is driven, negative intake pressure is developed in the evaporated fuel processing device 10 when the purge valve 39 is opened. Consequently, due to pressure equilibration, air in the surrounding atmosphere (fresh air) is immediately introduced in the auxiliary adsorption chamber 20 from the atmospheric port 26. This air allows the evaporated fuel to be successively desorbed from the adsorption material 46 within the upper chamber of the auxiliary adsorption chamber 20, the granular adsorbent material 55 included in the elastic adsorption member 53 within the middle chamber, and the adsorption material 48 within the lower chamber. The air flows further on through the communication passage 22, further successively desorbing evaporated fuel from the adsorption material 41 in the main adsorption chamber 18, and said air containing the evaporated fuel is then discharged, i.e., purged into the intake pipe 37 through the purge passage 34, from the purge port 25. Accordingly, the evaporated fuel is subjected to combustion treatment in the engine 36.

As described above, the evaporated fuel processing device 10 includes the elastic adsorption member 53 received in the case 12. The elastic adsorption member 53 includes the granules of the granular adsorbent material 55, that adsorb and desorb the evaporated fuel emissions, and the air-permeable elastic body 57 that has elasticity and air-permeability. The granules are randomly arranged within the air-permeable elastic body 57. In this way, the air-permeable elastic body 57 can elastically support the granules of the granular adsorbent material 55 while ensuring air-permeability with respect to the same. Consequently, the vibration of the granular adsorbent materials 55 caused while the evaporated fuel processing device 10 is vibrated, by e.g. operation of the vehicle, may be reduced. Further, pulverization of the granular adsorbent material 55 may be prevented. This in turn may prevent an increase in flow resistance of air passing through the case 12 due to the presence of fine powders. This may also reduce the noise caused by mutual rubbing of the granules of the granular adsorbent material 55 due to the vibration.

The elastic adsorption member 53 may be supported within the auxiliary adsorption chamber 20 of the case 12 through utilizing the elasticity of the air-permeable elastic body 57, where as described above the cross section of 53 is bigger than that of 20 and utilizes a press-fit configuration. The elastic adsorption member 53 can be positioned at a middle position in the auxiliary adsorption chamber 20, vertically between granular adsorbent materials 46 and 48, respectively, forming a middle chamber utilizing the elasticity of the air-permeable elastic body 57, without providing any additional components. The elastic adsorption member 53 can be positioned with respect to the case 12 solely by press-fitting the elastic adsorption member 53 as a middle chamber in the auxiliary adsorption chamber 20 of the case 12 in a manufacturing line. In this manner, the elastic adsorption member 53 can be easily installed in the case 12, and due to the pre-formed configuration it is not necessary to fill the granular adsorbent material 55 in a randomly arranged manner in the case 12. As a result, manufacturing cost of the evaporated fuel processing device 10 can be reduced.

The air-permeable elastic body 57 is made of urethane foam. As a result, the air-permeable elastic body 57 can ensure air-permeability with respect to the granular adsorbent material 55 while at the same time elastically supporting the same by utilizing elasticity of the urethane foam.

The constituent granules of the granular adsorbent material 55 may include through-holes 55a having a columnar shape and penetrating through the constituent granules in a longitudinal axial direction. Through these through-holes, air-flow resistance of a volume including the granular adsorbent material 55 with constituent granules that have the through-holes 55a is smaller as compared to air-flow resistance of a volume including the columnar granular adsorbent material 55 without said through-holes 55a. A surface area of each granular adsorbent material 55 is substantially enlarged because of the through-holes 55a. As a result, the evaporated fuel adsorption performance of the granular adsorbent material 55 is increased.

The granules of the granular adsorbent material 55 are larger than the granules of the adsorbent materials 41, 46 and 48. For example, the diameter 55d of the granules of the granular adsorbent material 55 is larger than the mean grain diameter of the granules of the adsorbent materials 41, 46 and 48. Each constituent granule of the granular adsorbent material 55 includes the through-holes 55a penetrating in a longitudinal axial direction thereof. Therefore, due to a larger surface area of adsorbent area resulting from the larger diameter, air-flow resistance of a volume including the granular adsorbent material 55 is smaller than air-flow resistance of a volume including the adsorbent materials 41, 46 or 48.

Instead of the structure shown in FIG. 1, the evaporated fuel processing device may alternately have a structure shown in FIG. 4. The evaporated fuel processing device 60 shown in FIG. 4 has a main canister 11 and a trap canister 62.

As shown in FIG. 4, the trap canister 62 includes a hollow trap case (case) 64 made of resin. The trap case 64 includes a hollow rectangular prismatic trap case main body 65 and upper and lower cover plates 66 and 68 for closing upper and lower ends of the trap case main body 65. A connecting port 67 is formed at the upper cover plate 66, which communicates with the interior of the trap case 64. An atmospheric port 69 is formed at the lower cover plate 68, which is in fluid communication with the interior of the trap case 64 and acts as an open conduit, facilitating fluid communication of the trap case 64 interior with the surrounding exterior atmosphere. The atmospheric port 69 is open to the atmosphere.

As shown in FIG. 4, adsorbent material 71 is filled within the trap case 64. The adsorbent material 71 comprises dispersed grains and is deposited in the trap case 64. For example, the adsorbent material 71 may be the same as the adsorbent material 41 filled in the main adsorption chamber 18 or it may also be a different type of granular activated carbon from the adsorbent material 41. An upper surface and a lower surface of the deposited adsorbent material 41 are respectively covered with a sheet filter (not shown).

The connecting port 26 of the main canister 11 is the same member as of the atmospheric port 26 in FIG. 1. The connecting port 26 is connected to the connecting port 67 of the trap canister 62 through a connecting pipe 73.

As shown in FIG. 4, the main canister 11 includes the main adsorption chamber 18, the auxiliary adsorption chamber 20 and the communication passage 22. The main adsorption chamber 18 and the communication passage 22 are configured in a similar manner as the main adsorption chamber 18 and the communication passage 22 shown in FIG. 1. However, in this alternative embodiment, the auxiliary adsorption chamber 20 adopts a different configuration, where it is divided into only upper and lower chambers and does not include the adsorption material 46 shown in FIG. 1. Here, the elastic adsorption member 53 is received within the upper chamber, wherein the elastic adsorption member 53 is configured in a similar manner as the elastic adsorption member 53 shown in FIG. 1. The adsorbent material 48 is filled in the lower chamber of the auxiliary adsorption chamber 20. The constituent granules of adsorbent material 48 are the same as those of the adsorbent material 48 shown in FIG. 1, where however the volume occupied by the granules of the adsorbent material 48 filled in the lower chamber is greater than the volume shown in FIG. 1.

Instead of the structure shown in FIG. 4, the evaporated fuel processing device may have a structure shown in FIG. 5. The evaporated fuel processing device 61 shown in FIG. 5 includes the main canister 15 and the trap canister 62. The trap canister 62 is configured similar to the trap canister 62 shown in FIG. 4. The main canister 15 includes the main adsorption chamber 18, the auxiliary adsorption chamber 20 and the communication passage 22. The main adsorption chamber 18 and the communication passage 22 are configured in a similar manner as the main adsorption chamber 18 and the communication passage 22 shown in FIG. 4, respectively.

As shown in FIG. 5, the auxiliary adsorption chamber 20 is divided in upper and lower chambers, where the adsorbent material 48 is filled in the upper chamber. The constituent granules of adsorbent material 48 are the same as those of the adsorbent material 48 shown in FIG. 4. The elastic adsorption member 53 is received within the lower chamber, wherein the elastic adsorption member 53 is configured in a manner substantially similar to the elastic adsorption member 53 of FIG. 4.

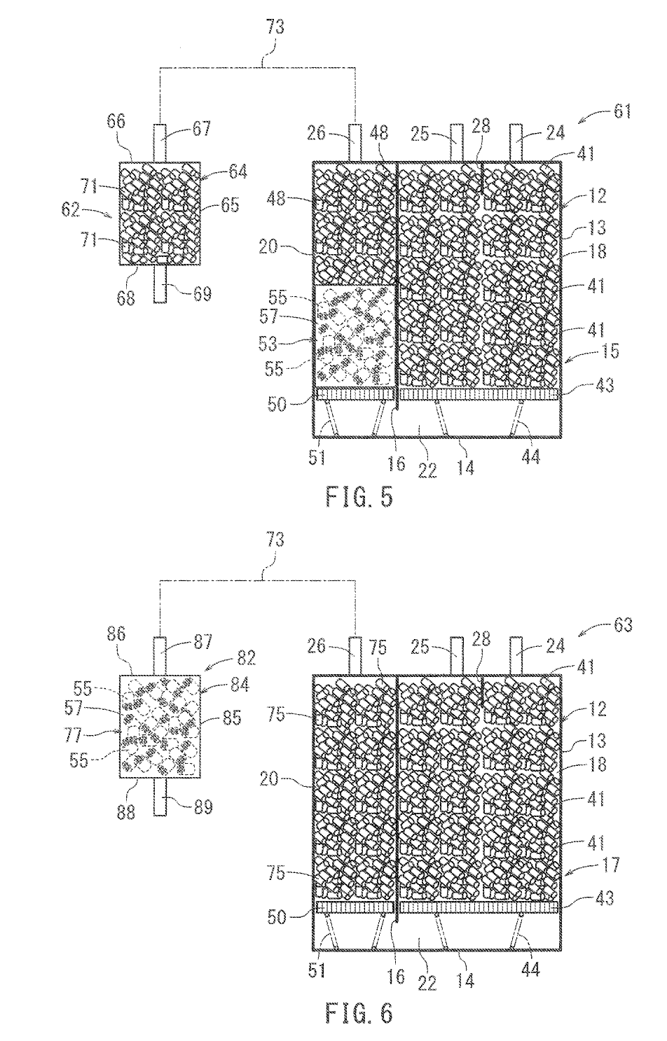

As a further alternative, instead of the structure shown in FIG. 4, the evaporated fuel processing device may have the structure shown in FIG. 6. As shown in FIG. 6, the evaporated fuel processing device 63 includes the main canister 17 and a trap canister 82. The main canister 17 includes the main adsorption chamber 18, the auxiliary adsorption chamber 20 and the communication passage 22. The main adsorption chamber 18 and the communication passage 22 are configured in a similar manner as the main adsorption chamber 18 and the communication passage 22 shown in FIG. 4.

As shown in FIG. 6, the auxiliary adsorption chamber 20 of the main canister 17 is composed of a solitary chamber. This auxiliary adsorption chamber 20 is filled with the adsorbent material 75. The constituent granules of the adsorbent material 75 are dispersed grains that are deposited in the auxiliary adsorption chamber 20. The constituent granules of adsorbent material 75 are, for example, the same as those of the adsorbent material 41. An upper surface and a lower surface of the deposited adsorbent material 75 are respectively covered with a sheet filter (not shown).

As shown in FIG. 6, the trap canister 82 includes the hollow trap case 84 made of resin. The trap case 84 includes the hollow cylindrical trap case main body 85 and upper and lower cover plates 86 and 88 for closing upper and lower ends of the trap case main body 65. A connecting port 87, which is in fluid communication with the interior of the trap case 64, is formed at the upper cover plate 86. An atmospheric port 89, which communicates with the interior of the trap case 64, is formed at the lower cover plate 88. The atmospheric port 89 is opened to and in fluid communication with the atmosphere.

As shown in FIG. 6, an elastic adsorption member 77 is received within the trap case (case) 84. Similar to the configuration of the elastic adsorption member 53 described in FIG. 1 with respect to chamber 20, here too a flat cross section of the elastic adsorption member 77 in a free state is larger than and approximately similar in shape to the flat cross section of the trap case 84. The elastic adsorption member 77 is thus press-fitted in the trap case main body 85 of the case 84. The elastic adsorption member 77 is supported within the trap case main body 85 through the elastic nature of its constituent material, wherein the elastic adsorption member 77 is configured in a similar manner as the elastic adsorption member 53 of FIGS. 1 and 4.

As shown in FIG. 1, the evaporated fuel processing device includes the elastic adsorption member 53 confined within one area of case 12. Alternatively, the evaporated fuel processing device may include the elastic adsorption members 53 in a plurality of areas within the case 12. As a further alternative, the evaporated fuel processing device may include elastic adsorption members 53 in all areas within the case 12. As a result, facilities necessary for filling the granular adsorbent materials may be eliminated in totality so that the manufacturing cost may be further reduced.

As shown in FIG. 3, a cross section of the through hole 55a of the granular adsorbent material 55 may have a fan-shape. Alternatively, it may also have other shapes such as an elliptical shape, circular shape or rectangular shape, etc. The constituent granules of the granular adsorbent material 55 may each have four through-holes 55a as shown in FIG. 3. Alternatively, each granule may also have only one or a plurality of through-hole(s) 55a. The constituent granules of the granular adsorbent material 55 may have the through-holes 55a as shown in FIG. 3. Alternatively, said granules may also be solid without any through-hole. The constituent granules of the adsorbent material 55 may have a columnar shape as shown in FIG. 3. Alternatively, said granules may also have another shape such as a quadrangular cylindrical shape, pentagonal cylindrical shape or hexagonal cylindrical shape, etc.

The granular adsorbent material 55 may be the same activated carbon as used for adsorbent material 41, 46, 48, 71. Alternatively, it may also be a different activated carbon. The elastic adsorption member 53 may include only one type of the granular adsorbent material 55. Alternatively, it may also include a variety of different types of granular adsorbent materials. The adsorbent materials 41, 46, 48, 71 may have the same or different mean particle diameters, or may also be made from different materials.

The various examples described above in detail with reference to the attached drawings are intended to be representative of the present disclosure and thus non limiting embodiments. The detailed description is intended to teach a person of skill in the art to make, use and/or practice various aspects of the present teachings and thus does not limit the scope of the disclosure in any manner. Furthermore, each of the additional features and teachings disclosed above may be applied and/or used separately or with other features and teachings in any combination thereof, to provide improved evaporated fuel processing devices, and/or methods of making and using the same.

What is claimed is:

1. An evaporated fuel processing device for processing evaporated fuel generated in a fuel tank, comprising:
a hollow case; and
an elastic adsorption member with a block shape disposed within the hollow case;
wherein the elastic adsorption member includes a plurality of constituent granules of a granular adsorbent material and an air-permeable elastic body, wherein the constituent granules of the granular adsorbent material are configured to adsorb and desorb evaporated fuel, and wherein the constituent granules are randomly arranged within the interior of the air-permeable elastic body.

2. The evaporated fuel processing device of claim 1, wherein the elastic adsorption member is supported within the hollow case in a compressed configuration via elasticity of the air-permeable elastic body.

3. The evaporated fuel processing device of claim 1, wherein the air-permeable elastic body is comprised of urethane foam.

4. The evaporated fuel processing device of claim 1, wherein the constituent granules of the granular adsorbent material each include at least one through-hole that has a columnar shape and penetrates in a longitudinal axial direction with respect to each of the constituent granules.

5. An evaporated fuel processing device for processing evaporated fuel generated in a fuel tank, comprising:
a rectangular prismatic hollow case with a vertical partition plate dividing the hollow case into a first subcase and a second subcase, wherein the first subcase comprises a tubular atmospheric port disposed along an outer periphery of the first subcase, wherein the tubular atmospheric port is in fluid communication with both an interior of the first subcase and the outside atmosphere, wherein the second subcase comprises a tubular purge port disposed along an outer periphery of the second subcase, wherein the tubular purge port is in fluid communication with an interior of the second subcase and an intake pipe of a vehicle, wherein the second subcase also includes a tubular tank port disposed along the outer periphery of the second subcase, wherein the tubular tank port is in fluid communication with the interior of the second subcase, wherein the tubular tank port are configured to fluidly communicate with the fuel tank, and
an elastic adsorption member formed of urethane foam having a rectangular prismatic block shape, wherein the elastic adsorption member is press-fit into and received within the first subcase, wherein the elastic adsorption member is vertically positioned in the middle of the first subcase;
wherein the elastic adsorption member includes a first plurality of constituent granules of a granular adsorbent material and an air-permeable elastic body, wherein the first plurality of constituent granules of the granular adsorbent material are configured to adsorb and desorb evaporated fuel, and wherein the first plurality of constituent granules are randomly arranged within the interior of the air-permeable elastic body.

6. The evaporated fuel processing device of claim 5, further comprising a second plurality of constituent granules of a granular adsorbent material configured to adsorb and desorb evaporated fuel, wherein the first plurality of constituent granules of the granular adsorbent material and the second plurality of constituent granules of the granular adsorbent material comprise different types of granular activated carbon materials, wherein the second plurality of constituent granules of the granular adsorbent material are disposed in the first subcase above and below the elastic adsorption member;
a third plurality of constituent granules of a granular adsorbent material configured to adsorb and desorb evaporated fuel, wherein the third plurality of constituent granules of the granular adsorbent material are disposed in the second subcase.

7. The evaporated fuel processing device of claim 6, wherein the second plurality of constituent granules of the granular adsorbent material comprises a first type of granular activated carbon material and a second type of granular activated carbon material that is different from the first type of granular activated carbon material, wherein the first type of granular activated carbon material of the second plurality of constituent granules of a granular adsorbent material is positioned in the first subcase above the elastic adsorption member and the second type of granular activated carbon material of the second plurality of constituent granules of a granular adsorbent material is positioned in the first subcase below the elastic adsorption member;
wherein the third plurality of constituent granules of the granular adsorbent material comprises a third type of granular activated carbon material that is different from the first type of granular activated carbon material and the second type of granular activated carbon material.

8. The evaporated fuel processing device of claim 7, wherein the tank port of the second subcase is configured to receive the evaporated fuel, wherein the first plurality of constituent granules of the granular adsorbent material and the second plurality of constituent granules of the granular adsorbent material are configured to adsorb the evaporated fuel in the first subcase, and wherein the third plurality of constituent granules of the granular adsorbent material are configured to adsorb the evaporated fuel in the second subcase.

9. The evaporated fuel processing device of claim 7, wherein the tubular purge port on the outer periphery of the second subcase is in fluid communication with an engine of the vehicle through the intake pipe, wherein when through operation of said engine a negative pressure is created within the interior of the second subcase of the hollow case through the purge port, the device due to the first subcase comprising air-permeable structure, undergoes pressure-equilibration and further includes an influx of air in the first subcase which enters the device through the atmospheric port, wherein the structure of the device is configured such that the air may travel from top through bottom of the first subcase, through elastic adsorption member, and around the vertical partition plate to the interior of the second subcase, and then exit the device through the purge port of the second subcase, wherein upon exiting the air also constitutes desorbed fuel from constituent granules within the device.

10. The evaporated fuel processing device of claim 7, wherein each of the constituent granules of the first plurality of constituent granules of the granular adsorbent material includes a plurality of fan shaped through-holes extending in a longitudinal direction of each of the constituent granules of the first plurality of constituent granules of the granular adsorbent material, where said through-holes are uniformly circumferentially-spaced, where a mean particle diameter of said granules of the first plurality of constituent granules of the granular adsorbent material is larger than a mean particle diameter of the granules of the second plurality of constituent granules of the granular adsorbent material and a mean particle diameter of said granules of the third plurality of constituent granules of the granular adsorbent material.
